(19) United States
(12) Patent Application Publication
(10) Pub. No.: US 2024/0054256 A1
(43) Pub. Date: Feb. 15, 2024

(54) Computer-aided design system and method for processing digital data of a composite object

(71) Applicant: InnoLux Corporation, Miao-Li County (TW)

(72) Inventors: Yi-Hung Hsueh, Miao-Li County (TW); Wen-Hsien Huang, Miao-Li County (TW); Hung-Kuo Chu, Miao-Li County (TW); Kai-Wen Hsiao, Miao-Li County (TW)

(73) Assignee: InnoLux Corporation, Miao-Li County (TW)

(21) Appl. No.: 18/219,102

(22) Filed: Jul. 7, 2023

(30) Foreign Application Priority Data
Aug. 15, 2022 (CN) 202210975362.7

(51) Int. Cl. G06F 30/17

(52) U.S. Cl. CPC G06F 30/17; G06F 2113/26

(57) ABSTRACT

A processor of a computer-aided design system reads and executes a software stored in a memory to input first digital data of a first component of the composite object, input second digital data of a second component of the composite object, analyze the first digital data and the second digital data with first criterion to obtain a plurality of first surfaces and a plurality of second surfaces respectively, calculate a distance between one of the plurality of the first surfaces and one of the plurality of the second surfaces, and output a first result when the distance is greater than or equal to the first threshold; otherwise, output a second result.

### BACKGROUND OF THE DISCLOSURE

### 1. Field of the Disclosure

This disclosure relates to a computer-aided design (CAD) system and a method of processing digital data of a composite object, particularly relating to a computer-aided design system and method thereof capable of analyzing the digital data of different components in the composite object to evaluate the assembly risk when assembling the different components.

### 2. Description of the Prior Art

Traditionally, after completing the initial design drawings of each component in a composite object, the manufacturer would make molding to produce samples of each component to determine the compatibility of each component during assembly. Due to the high cost of molding, when there are assembly compatibility problems, it is often necessary to modify the mold or start over, resulting in increased development costs. Furthermore, the composite object assembled from the components usually faces the following problems in the design and production process: first, although the sizes of the produced components meet the requirements, the composite object exceeds the requirements after assembly; second, the large-sized components have more assembly joints, and the number of measurement surface ball markers (BOM Balloons) to be measured is relatively large, making measurement difficult and time-consuming; third, to confirm whether the composite object meets the requirements, most of it is measured by manual disassembly of each component, and these disassembly or assembly processes are destructive to the components, making the composite object difficult to preserve.

### SUMMARY OF THE DISCLOSURE

The present disclosure provides a computer-aided design system that comprises a storage device and a processor. The storage device stores software. The processor is coupled to the storage device, reads the software from the storage device, and performs the following operations by executing the software: inputting first digital data of a first component of a composite object; inputting second digital data of a second component of the composite object; analyzing the first digital data and the second digital data according to a first criterion to respectively obtain a plurality of first surfaces and a plurality of second surfaces; calculating a distance between one of the first surfaces and one of the second surfaces; and outputting a first result when the distance is greater than or equal to a first threshold, and outputting a second result when the distance is less than the first threshold.

Another embodiment of the present disclosure provides a method for processing digital data of a composite object. The method comprises inputting first digital data of a first component of the composite object; inputting the second digital data of the second component of the composite object; analyzing the first digital data and second digital data according to a first criterion to respectively obtain a plurality of first surfaces and a plurality of second surfaces; calculating a distance between one of the first surfaces and one of the second surfaces; and outputting a first result when the distance is greater than or equal to a first threshold, and outputting a second result when the distance is less than the first threshold.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a functional block diagram of an embodiment of the computer-aided design system of the present disclosure.

FIG. 2 is a flowchart of a method of processing digital data of the composite object of the computer-aided design system shown in FIG. 1.

FIG. 3 illustrates a data structure used by the computer-aided design system shown in FIG. 1.

FIG. 4 illustrates a plurality of triangular pieces generated by the processor of the computer-aided design system shown in FIG. 1.

FIG. 5 illustrates various categories used by the processor of the computer-aided design system shown in FIG. 1 to classify the triangular pieces.

FIG. 6 illustrates a plurality of surfaces formed by the triangular pieces in FIG. 4 determined by the processor in FIG. 1.

FIG. 7 illustrates an example when the processor in FIG. 1 determines whether the triangular pieces are on the same surface.

FIG. 8 illustrates how the cosine of the predetermined angle affects the processor's determination of whether adjacent triangular pieces can form the same surface when the triangular pieces are classified in the same category as the fourth category, the fifth category, or the sixth category.

FIG. 9 illustrates how the processor in FIG. 1 determines the relationship between the first threshold and the distance between two surfaces of the paired combination.

FIG. 10 is a flow chart of a method for processing digital data of composite object in another embodiment of the computer-aided design system in FIG. 1.

### DETAILED DESCRIPTION

The present disclosure can be understood by referring to the detailed description below and in conjunction with the accompanying drawings. It should be noted that, in order to make it easy for readers to understand and to keep the illustrations concise, only a part of the electronic device is shown in each of the a plurality of drawings, and specific components in the drawings are not drawn to scale. In addition, the number and size of the components in the drawings are for illustrative purposes only and are not intended to limit the scope of the present disclosure.

Throughout this specification and the appended claims, certain terms will be used to refer to particular components. Those skilled in the art should understand that electronic device manufacturers may use different names to refer to the same components.

The present disclosure does not intend to distinguish between components that have the same function but different names. In the following specification and claims, the terms “comprising,” “including,” and “having” are open-ended terms and should be interpreted to mean “including but not limited to . . . ”

It should be understood that when a component is referred to as being “on,” “mounted on,” or “coupled to” another component, it may be directly on or coupled to the other component, or there may be an inserted component (non-direct situation) between them.

Conversely, when a component is referred to as being “directly” on, “directly mounted on,” or “directly coupled to” another component, there is no inserted component between them.

When a component is referred to as being “electrically connected” or “coupled” to another component in the present specification, this may comprise situations where there may be other components between the two components that are electrically connected, or situations where there are no other components between the two components and they are directly electrically connected. If a component is referred to as being “directly electrically connected” or “directly coupled” to another component in the specification, this means that there is no other component between the two components.

Although the terms “first,” “second,” “third,” etc. can be used to describe various constituent components, the constituent components are not limited by these terms. These terms are only used to distinguish a single constituent component in the specification from other constituent components. Different terms may be used in the claims according to the order in which the components are declared. Therefore, in the following specification, the first constituent component may be the second constituent component in the claims.

The terms “approximately, ““equal to, ““substantially equal, ““substantially the same,” “substantially,” or “approximately” generally mean within 20% of the given value or range, or within 10%, 5%, 3%, 2%, 1%, or 0.5% of the given value or range.

It should be understood that the following embodiments may have various technical features replaced, rearranged, mixed and matched from different embodiments to complete other embodiments, as long as they do not conflict with or depart from the spirit of the present disclosure.

The disclosed electronic device may include electronic components. The electronic device may include, for example, a display device, a lighting device, an antenna device, a sensing device, a touch electronic device (e.g., a touch display), a curved electronic device (e.g., a curved display), or a non-rectangular electronic device (e.g., a free shape display), but not limited to these. The electronic device may be a bendable or flexible electronic device.

The electronic device may include, for example, light-emitting diodes, fluorescence, phosphors, other suitable display media, or combinations thereof, but not limited to these. Electronic components may include passive components and active components, such as capacitors, resistors, inductors, diodes, transistors, etc. Diodes may include light-emitting diodes or photodiodes. Light-emitting diodes may include organic light-emitting diodes (OLED), mini LEDs, micro LEDs, or quantum dot (QD) light-emitting diodes (such as QLED, QDLED), or other suitable materials or any combination of these materials, but not limited to these. The display device may include a splicing display device, but not limited to this. The antenna device may be a liquid crystal antenna, but not limited to this. It should be noted that the electronic device may be any combination of the above, but not limited to these. In addition, the shape of the electronic device may be rectangular, circular, polygonal, with curved edges, or any other suitable shape. The electronic device may have peripheral systems such as a driving system, a control system, a light source system, a layering system, etc., to support the display device or splicing device. It should be noted that the electronic device may be any combination of the above, but not limited to these. The electronic device may include multiple components, and at least two components may be assembled to form a composite object. The following will use a display device as an example to illustrate the disclosure, but the disclosure is not limited to this.

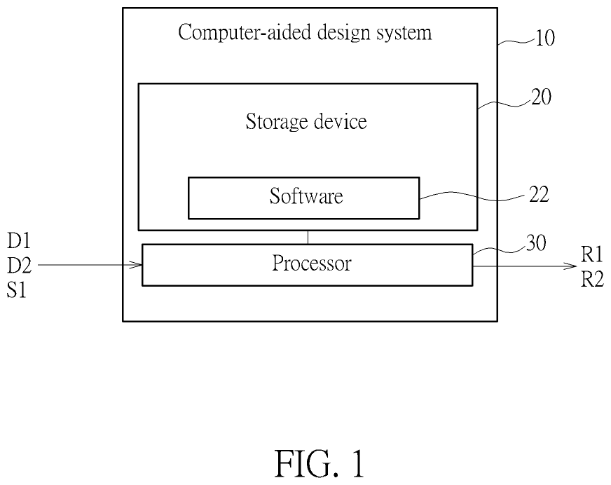

FIG. 1 is a functional block diagram of a computer-aided design (CAD) system 10 in an embodiment of the present disclosure. The CAD system 10 can be implemented on a server, personal computer, or other electronic device with computing capabilities. The CAD system 10 comprises a storage device 20 and a processor 30. The storage device 20 is used to store software 22, and the storage device 20 may comprise non-transitory computer-readable storage media, such as but not limited to magnetic disks, optical disks, magneto-optical (MO) disks, and semiconductor memories. Magnetic disks comprise floppy disks and hard disks, while optical disks comprise compact discs (CDs) and digital versatile discs (DVDs). Semiconductor memories comprise solid-state disks (SSDs) and resistive random-access memories (RRAM or ReRAM). The processor 30 is coupled to the storage device 20 to read the software 22 from the storage device 20, and perform part of the operations of the CAD system 10 by executing the software 22.

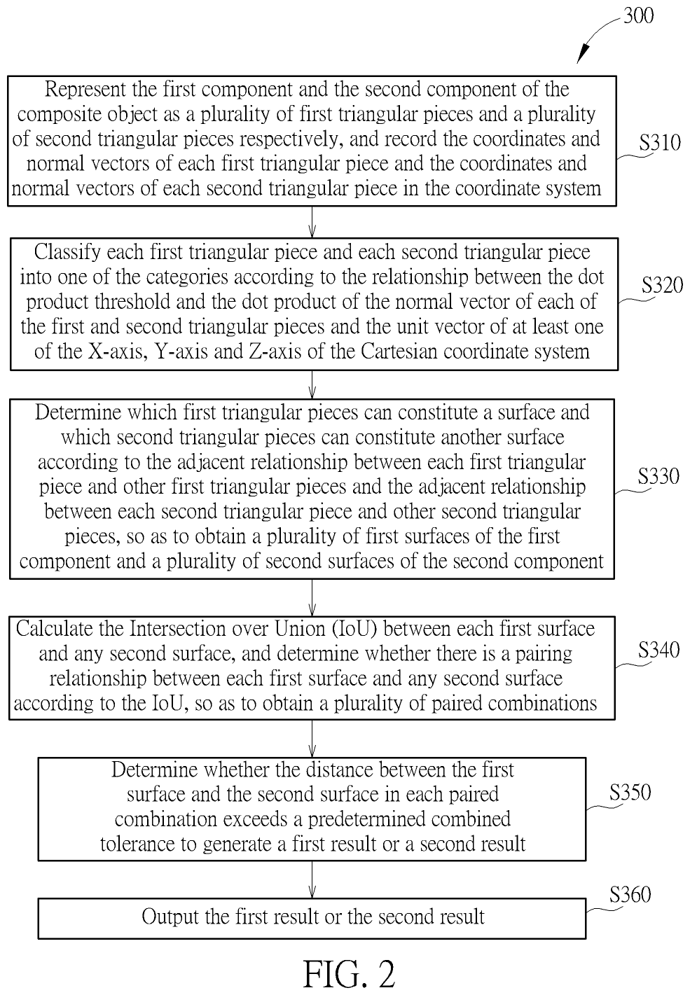

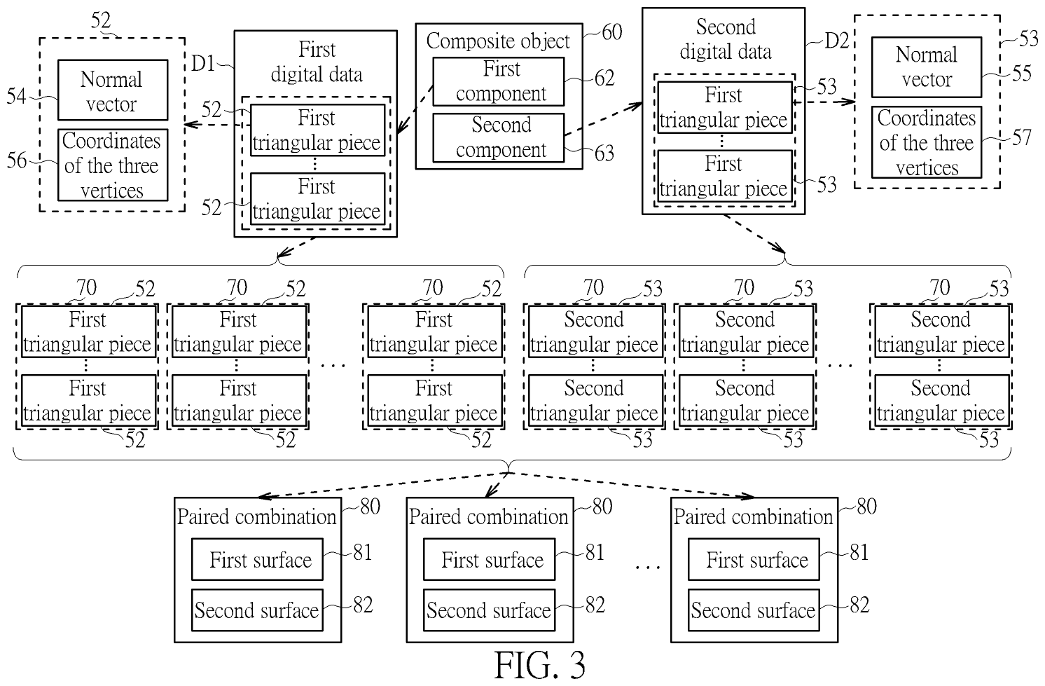

The operations performed by the processor 30 by executing the software 22 can be represented by steps S310 to S360 in the flowchart of the method 300 illustrated in FIG. 2 for processing the digital data of the composite object. FIG. 2 is a flowchart of a method of processing digital data of the composite object of the computer-aided design system shown in FIG. 1, and FIG. 3 is used to assist in explaining the data structure used by the CAD system 10 in FIG. 1 when the steps in FIG. 2 are executed. The CAD system 10 mainly displays a 3D representation of a plurality of components of the composite object 60 (e.g., a first component 62 and a second component 63), and the composite object 60 can be a case or part of a product, and the plurality of components are assembled into the composite object 60 by, for example, locking or snapping. Although FIG. 3 only shows two components of the composite object 60 (i.e., the first component 62 and the second component 63), the composite object 60 may comprise three or more components, but is not limited to this. The processor 30 can process first digital data D1 of the first component 62 of the composite object 60 and the second digital data D2 of the second component 63 of the composite object 60 shown in FIG. 3, and display the first component 62 and second component 63 in 3D representation.

The method 300 for processing digital data of the composite object 60 shown in FIG. 2 comprises the following steps:
Step S310: Represent the first component 62 and the second component 63 of the composite object 60 with a plurality of first triangular pieces 52 and a plurality of second triangular pieces 53 respectively, and record the coordinates and normal vectors of each first triangular piece 52 in a coordinate system (such as Cartesian coordinate system). Taking the Cartesian coordinate system as an example, the processor 30 records the normal vector 54 and the coordinates of the three vertices 56 for each first triangular piece 52, and records the normal vector 55 and the coordinates of the three vertices 57 for each second triangular piece 53;
Step S320: Classify each first triangular piece 52 and each second triangular piece 53 into one of a plurality of categories 70 according to the relationship between the dot product threshold and the dot product of the normal vector of each of the first and second triangular pieces and the unit vector of at least one axis (X, Y, or Z) of the Cartesian coordinate system;
Step S330: Determine which first triangular pieces 52 can constitute a surface and which second triangular pieces 53 can constitute another surface according to the adjacent relationship between each first triangular piece 52 and other first triangular pieces 52 and the adjacent relationship between each second triangular piece 53 and other second triangular pieces 53, so as to obtain a plurality of first surfaces 81 of the first component 62 and a plurality of second surfaces 82 of the second component 63;
Step S340: Calculate the Intersection over Union (IoU) between each first surface 81 and any second surface 82, and determine whether there is a pairing relationship between each first surface 81 and any second surface 82 according to the IoU, so as to obtain a plurality of paired combinations 80;
Step S350: Determine whether the distance between the first surface 81 and the second surface 82 in each paired combination 80 exceeds a predetermined combination tolerance to generate a first result R1 or a second result R2; and
Step S360: Output the first result R1 or the second result R2, wherein the first result R1 is outputted when the distance between the first surface 81 and the second surface 82 is greater than or equal to the predetermined combination tolerance, and the second result R2 is outputted when the distance between the first surface 81 and the second surface 82 is less than the predetermined combination tolerance.

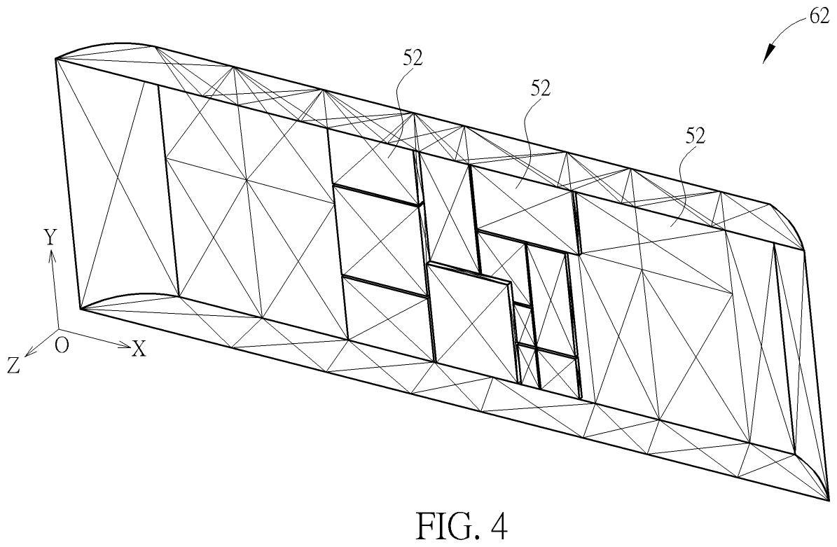

In step S310, as shown in FIG. 2, the first component 62 and the second component 63 of the composite object 60 are respectively represented by a plurality of first triangular pieces 52 and a plurality of second triangular pieces 53. FIG. 4 illustrates a plurality of first triangular pieces 52 of the first component 62 of the composite object 60 generated by the processor 30. The data (including but not limited to coordinates and normal vectors) of each first triangular piece 52 of the first component 62 and each second triangular piece 53 of the second component 63 of the composite object 60 can be analyzed and generated by the processor 30, and may comprise the first digital data D1 and the second digital data D2, respectively. In another embodiment of the present disclosure, the first digital data D1 and the second digital data D2 may be stored as a digital file in wavefront format (with file extension OBJ). In another embodiment of the present disclosure, the processor 30 can obtain the first digital data D1 and the second digital data D2 by converting a digital file, which may comprise but is not limited to STEP format (file extension stp) of drawing software Pro/E, IGES format (file extension igs) of drawing software SOLIDWORKS, and universal 3D model formats such as Unity3D format (file extension u3d), FBX format (file extension fbx), and polygonal file format (file extension ply).

In step S320, processor 30 performs a dot product operation between the normal vector 54 of each first triangular piece 52 with at least one unit vector of the X-axis, Y-axis, and Z-axis in Cartesian coordinate system, and performs a dot product operation between the normal vector 55 of each second triangular piece 53 with at least one unit vector of the X-axis, Y-axis, and Z-axis in Cartesian coordinate system. The resulting dot product is then compared with a dot product threshold to classify the first triangular pieces 52 and second triangular pieces 53. For example, suppose a first triangular piece 52 is denoted as tₙ, and its normal vector 54 is represented as t̅ₙ, while the unit vectors of the X-axis, Y-axis, and Z-axis are represented as X̅, Y̅, and Z̅, respectively. The dot product threshold is denoted as δ, where 0≤δ≤1. The processor 30 can classify the first triangular piece 52 according to the following pseudo code:

```
// If the absolute value of the dot product of \vec{t}ₙ and \vec{X} minus one
// is less than or equal to δ,
// then triangular piece tₙ is X-orthogonal triangle.
If (∥\vec{t}ₙ · \vec{X}|−1|≤δ),
    then tₙ is X-orthogonal triangle;
// If the absolute value of the dot product of \vec{t}ₙ and \vec{Y} minus one
// is less than or equal to δ,
// then triangular piece tₙ is Y-orthogonal triangle.
Else if (∥\vec{t}ₙ · \vec{Y}|−1|≤δ),
    then tₙ is Y-orthogonal triangle;
// If the absolute value of the dot product of \vec{t}ₙ and \vec{Z} minus one
// is less than or equal to δ,
// then triangular piece tₙ is Z-orthogonal triangle.
Else if (∥\vec{t}ₙ · \vec{Z}|−1|≤δ),
    then tₙ is Z-orthogonal triangle;
// If the absolute value of the dot product of \vec{t}ₙ and \vec{X}
// is less than or equal to δ,
// then triangular piece tₙ is X-incline triangle.
Else if (|\vec{t}ₙ · \vec{X}|≤δ),
    then tₙ is X-incline triangle;
// If the absolute value of the dot product of \vec{t}ₙ and \vec{Y}
// is less than or equal to δ,
// then triangular piece tₙ is Y-incline triangle.
Else if (|\vec{t}ₙ · \vec{Y}|≤δ),
    then tₙ is Y-incline triangle;
// If the absolute value of the dot product of \vec{t}ₙ and \vec{Z}
// is less than or equal to δ,
// then triangular piece tₙ is Z-incline triangle.
Else if (|\vec{t}ₙ · \vec{Z}|≤δ),
  then tₙ is Z-incline triangle;
// Other triangular pieces are assigned to the seventh category.
Else
    others.
```

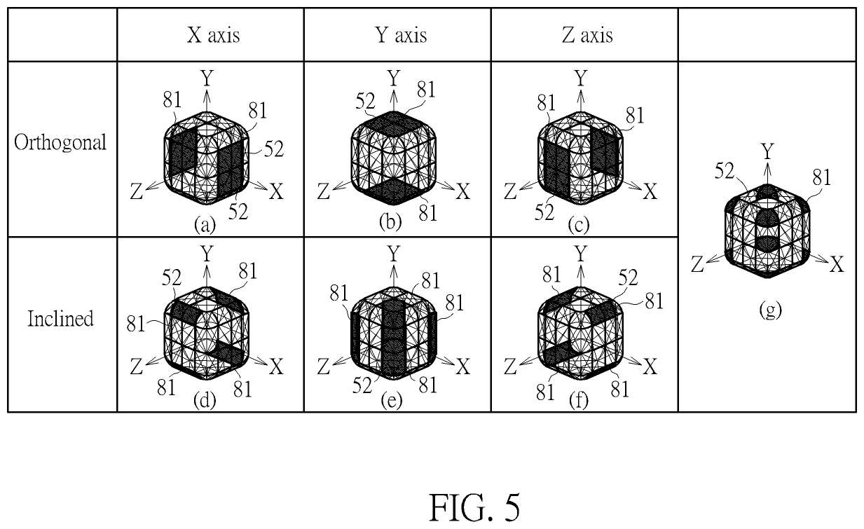

The unit vectors of the X, Y, and Z axes, denoted as X̅, Y̅, and Z̅, respectively, can be equal to (1,0,0), (0,1,0), and (0,0,1). According to the pseudo code above, all the first triangular pieces 52 and second triangular pieces 53 will be classified into one of the seven categories 70: X-orthogonal triangles (i.e., first category), Y-orthogonal triangles (i.e., second category), Z-orthogonal triangles (i.e., third category), X-incline triangles (i.e., fourth category), Y-incline triangles (i.e., fifth category), Z-incline triangles (i.e., sixth category), and others (i.e., seventh category). FIG. 5 is an example that illustrates these seven categories 70 using a plurality of first triangular pieces 52 of a die. In FIG. 5, the first triangular pieces 52 marked with dots in section (a) are X-orthogonal triangles, and they can form two first surfaces 81 orthogonal to the X-axis. The first triangular pieces 52 marked with dots in section (b) are Y-orthogonal triangles, and they can form two first surfaces 81 orthogonal to the Y-axis. The first triangular pieces 52 marked with dots in section (c) are Z-orthogonal triangles, and they can form two first surfaces 81 orthogonal to the Z-axis. The first triangular pieces 52 marked with dots in section (d) are X-incline triangles, and they can form four first surfaces 81 inclined with respect to the X-axis. The first triangular pieces 52 marked with dots in section (e) are Y-incline triangles, and they can form four first surfaces 81 inclined with respect to the Y-axis. The first triangular pieces 52 marked with dots in section (f) are Z-incline triangles, and they can form four first surfaces 81 inclined with respect to the Z-axis. The first triangular pieces 52 marked with dots in section (g) are triangles that do not belong to the above six categories 70, and eight first surfaces 81 formed by these first triangular pieces 52 will not be considered in the comparison of the Intersection over Union (IoU) of the first surface 81 of the first component 62 and the second surface 82 of the second component 63.

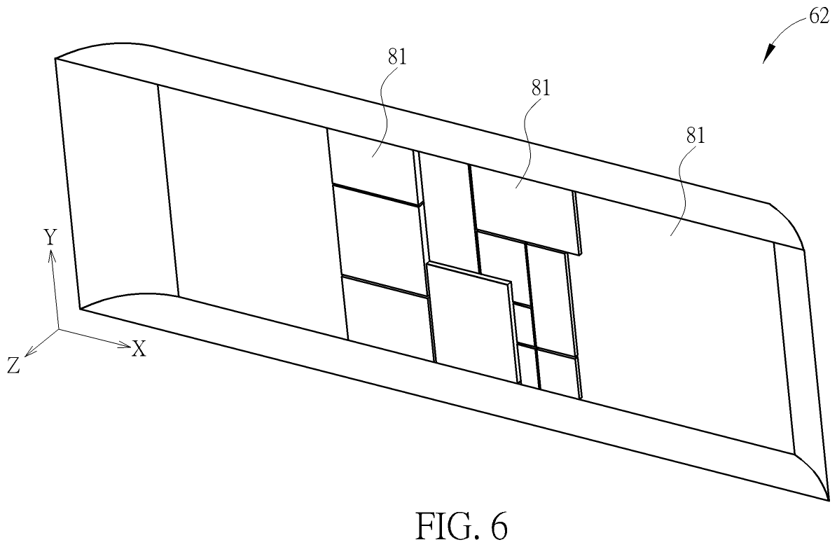

In step S330, as shown in FIG. 6, the processor 30 determines which first triangles 52 in FIG. 4 can form the same first surface 81. The same process can be applied to the second component 63 of the composite object 60, which will not be repeated here. In step S330, the processor 30 determines whether each triangle 52 is adjacent to any other triangle 52 according to the coordinates of the three vertices 56 of each first triangle 52. Then, the processor 30 determines whether any two adjacent first triangles 52 are on the same first surface 81 according to the classification of the first triangle 52 in step S320. In one embodiment, if two adjacent triangles tn1 and tn2, from the same component (e.g., first component 62 or second component 63), have normal vectors t̅ₙ₁ and t̅ₙ₂, respectively, the processor 30 can use the following pseudo code to make the determination in step S330:

```
/* If both tn1 and tn2 are X-orthogonal triangles, or Y-orthogonal
triangles, or Z-orthogonal triangles, then tn1 and tn2 are on the
same surface */
If both tₙ₁ and tₙ₂ are X-orthogonal triangles,
  then tₙ₁ and tₙ₂ are on the same surface;
Else if both tₙ₁ and tₙ₂ are Y-orthogonal triangles,
  then tₙ₁ and tₙ₂ are on the same surface;
Else if both tₙ₁ and tₙ₂ are Z-orthogonal triangles,
  then tₙ₁ and tₙ₂ are on the same surface;
/* If both tn1 and tn2 are X-incline triangles, or Y-incline triangles,
or Z-incline triangles, and the cosine of the predetermined angle
θ between and is greater than or equal to zero, then tn1 and tn2 are
on the same surface */
Else if (both tₙ₁ and the tₙ₂ are X-incline triangles) and (\vec{t}ₙ₁ · \vec{t}ₙ₂ ≥cosθ)),
  then tₙ₁ and tₙ₂ are on the same surface;
Else if (both tₙ₁ and tₙ₂ are Y-incline triangles) and (\vec{t}ₙ₁ · \vec{t}ₙ₂ ≥cosθ)),
  then tₙ₁ and tₙ₂ are on the same surface;
Else if (both tₙ₁ and tₙ₂ are Z-incline triangles) and (\vec{t}ₙ₁ · \vec{t}ₙ₂ ≥cosθ)),
  then tₙ₁ and tₙ₂ are on the same surface;
// All other triangles are not on the same surface
Else
    others.
```

In addition, in step S330, the processor 30 can use the Connected Component Labeling (CCL) algorithm to perform connected component analysis on the triangular pieces to determine which ones can form the same first surface 81 or second surface 82.

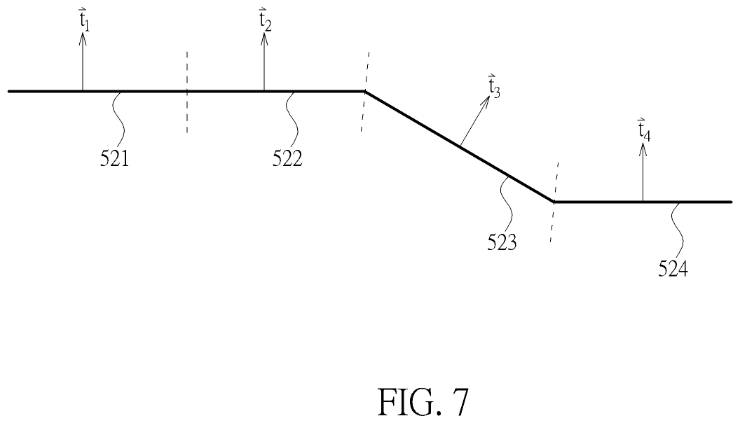

FIG. 7 illustrates an example in which the processor 30 determines whether triangular pieces are on the same first surface 81 or second surface 82 in step S330. FIG. 7 shows four adjacent triangular pieces 521, 522, 523, and 524 in a sectional view, and these four adjacent triangular pieces can all be the first triangular piece 52 or the second triangular piece 52, with their normal vectors being t̅₁, t̅₂, and t̅₃, respectively. The triangular piece 523 was not classified in the same category as the triangular pieces 521, 522, and 524 in step S320, while triangular pieces 521, 522, and 524 were classified in the same category. For example, triangular pieces 521, 522, and 524 are classified in the first category (i.e., X-orthogonal triangular pieces), the second category (i.e., Y-orthogonal triangular pieces), or the third category (i.e., Z-orthogonal triangular pieces). Since triangular piece 524 is separated from triangular pieces 521 and 522 by triangular piece 523, the processor 30 in step S330 does not recognize triangular piece 524 as being on the same surface as triangular pieces 521 and 522, even though triangular piece 524 is classified in the same category as triangular pieces 521 and 522.

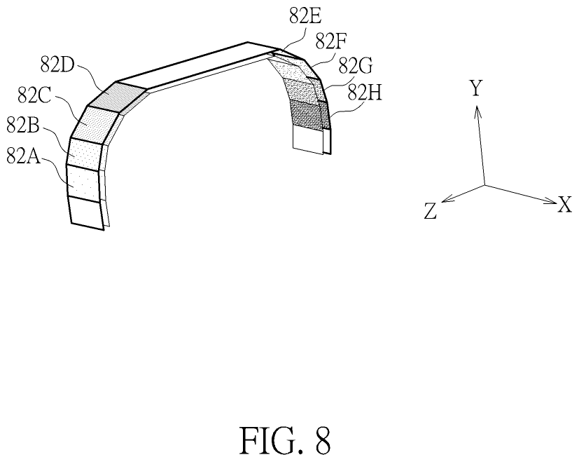

FIG. 8 illustrates how the cosine of the predetermined angle θ affects the processor's determination, in step S330, of whether adjacent triangular pieces can form the same surface when the triangular pieces are classified in the same category as the fourth category, the fifth category, or the sixth category. FIG. 8 shows eight surfaces, referred to as surfaces 82A to 82H, each of which can be formed by at least one triangular piece inclined with respect to the X-axis. In this embodiment, the surfaces 82A to 82H can all be the second surfaces 82 of the second component 63 or the first surfaces 81 of the first component 62, but the present disclosure is not limited thereto. When the angle θ is changed to increase the cosine of θ, the number of surfaces shown in FIG. 8 can be reduced from eight to seven or less; and when the angle θ is changed to decrease the cosine of θ, the number of surfaces shown in FIG. 8 can be increased from eight to nine or more.

In step S340, each paired combination 80 comprises two surfaces, one from the first surfaces 81 of the first component 62 and the other from the second surfaces 82 of the second component 63, which are in a pairing relationship determined in step S330. When the Intersection over Union (IoU) of the two surfaces is greater than or equal to a second threshold, the processor 30 determines these two surfaces as a paired combination 80 with a pairing relationship. The IoU of the two surfaces can be calculated as the intersection area of the two surfaces divided by the union area of the two surfaces. In one embodiment, the second threshold is set to 0.1, but the present disclosure is not limited to this value.

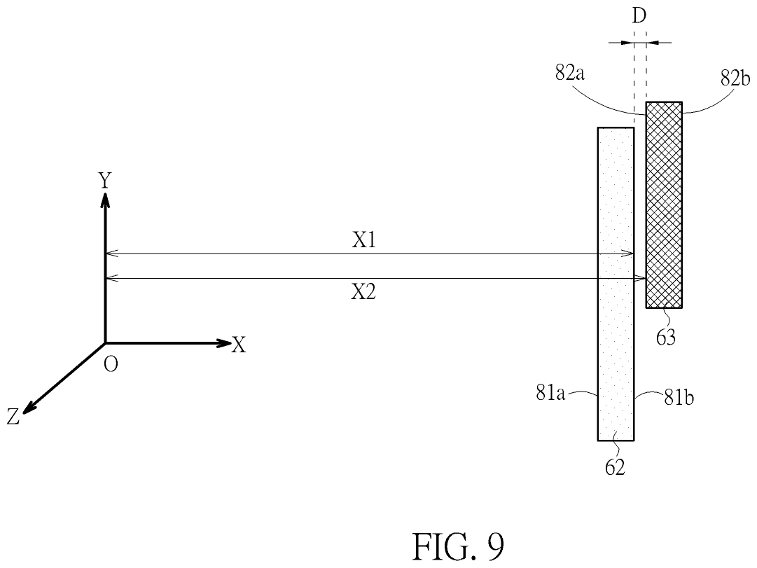

FIG. 9 illustrates how the processor 30 in FIG. 1 determines whether the maximum tolerance of the distance D between the two surfaces of the paired combination 80 exceeds the combination tolerance (i.e., a first threshold), which can be set in advance by the user or set during the determination of the paired combination by the user, and the present disclosure is not limited thereto. FIG. 9 shows the first component 62 and the second component 63 of the composite object 60 in FIG. 4, where the processor 30 determines in step S330 that the first component 62 has a first surface 81a and a first surface 81b, and the second component 63 has a second surface 82a and a second surface 82b. In addition, in step S340, the processor 30 determines that the first surface 81b and the second surface 82a have a paired combination relationship and can form a paired combination 80. In this embodiment, since the first surface 81b and the second surface 82a are constructed by triangular pieces orthogonal to the X axis, the processor 30 calculates a projection distance X1 of the origin O in the Cartesian coordinate system projected in the direction parallel to the X axis onto the first surface 81b, and calculates a projection distance X2 of the origin O in the direction parallel to the X axis projected onto the second surface 82a. Similarly, in another embodiment, if the first surface and the second surface in the paired combination 80 are constructed by triangular pieces orthogonal to the Y axis, the processor 30 will calculate the projection distance of the origin O in the direction parallel to the Y axis onto the first surface and the second surface respectively. In another embodiment, if the first surface and the second surface in the paired combination 80 are constructed by triangular pieces orthogonal to the Z axis, the processor 30 will respectively calculate the projection distance of the origin O in the direction parallel to the Z axis onto the first surface and the second surface. In another embodiment, if the first surface and the second surface in the paired combination 80 are both constructed by triangular pieces inclined with respect to the Z axis, the processor 30 would respectively calculate the maximum and/or minimum projection distance of the origin O in the direction parallel to the X axis onto the first surface, and would also respectively calculate the maximum and/or minimum projection distance of the origin O in the direction parallel to the X axis onto the second surface. If the processor 30 determines the risk of interference between the first and second surfaces during assembly, it can use the minimum distance of the first surface from the origin O and the minimum distance of the second surface from the origin O to determine the assembly risk. If the processor wants to determine the risk of separation between the first and second surfaces during assembly, it can use the maximum distance of the first surface from the origin O and the maximum distance of the second surface from the origin O to determine the assembly risk, but this is not limited thereto. In other embodiments, if the first surface and second surface of the paired combination 80 are constructed by triangular pieces oblique to the Y-axis or Z-axis, the processor 30 can calculate the maximum and/or minimum distance of the first surface from the origin O projected along the Z-axis or Y-axis and use them to determine the assembly risk. After calculating the projection distance, the processor 30 determines whether the distance D exceeds the assembly tolerance by using the tolerance of the projection distance X1 and the tolerance of the projection distance X2. The tolerance of the projection distance X1 and X2 can be the manufacturing tolerances of the first component and second component respectively, and the distance D is equal to the difference between the projection distance X2 and the projection distance X1 (i.e., D=X2−X1). In the disclosed embodiment, the processor 30 can use the Worst Case tolerance analysis method in step S350 to determine the range of distance D. For example, if the calculated projection distances X1 and X2 are 141.54 mm and 141.74 mm, respectively, and the tolerances for both projection distances are ±0.1 mm, then according to the Worst Case method, the maximum value of distance D is equal to ((X2+0.1)−(X1−0.1)) mm, which is ((141.74+0.1)−(141.54−0.1)) mm=0.4 mm, while the minimum value of distance D is equal to ((X2−0.1)−(X1+0.1)) mm, which is ((141.74−0.1)−(141.54+0.1)) mm=0 mm. If the allowable combination tolerance of distance D is set to be between 0 mm and 0.4 mm, then the range of distance D calculated by the Worst Case method (0 mm to 0.4 mm) is exactly the same as the combination tolerance (0 mm to 0.4 mm), so the processor 30 will determine that there is a higher probability of assembly risk when assembling the first component 62 with the first surface 81b and the second component 63 with the second surface 82a, i.e., the combination risk is higher. In another embodiment, the processor 30 may use the Root Sum Squares (RSS) method in step S350 to make the determination. For example, if the tolerances for the projection distances X1 and X2 are still ±0.1 mm, the processor 30 will first calculate the root mean square value of the two tolerances (i.e., 0.14 mm), and then respectively subtract and add the root mean square value from the distance D between projection distances X1 and X2 (i.e., 141.74−141.54=0.2 mm), to obtain the range of distance D after assembling the first surface 81b and the second surface 82a (i.e., 0.2±0.14 mm). Therefore, the maximum value of distance D is (0.2+0.14)=0.34 mm, while the minimum value of distance D is (0.2−0.14)=0.06 mm. If the combination tolerance is still between 0 mm and 0.4 mm, then the range (0.06 mm to 0.34 mm) of distance D calculated by the RSS method is within the range of combination tolerance (0 mm to 0.4 mm), so the processor 30 will determine that there is a lower probability of assembly risk when assembling the first component 62 with the first surface 81b and the second component 63 with the second surface 82a, i.e., the combination risk is lower. In another embodiment, if the tolerances for the projection distances X1 and X2 are still ±0.1 mm, the processor 30 would first classify the tolerances according to two levels. For example, the first level tolerance is ±0.02 mm and the second level tolerance is ±0.05 mm, but the disclosure is not limited to this. The processor 30 would use the worst-case or root sum squares analysis method to analyze the probability of assembly risk when assembling the first component 62 and the second component 63 by using different levels of tolerances for the projection distances X1 and X2. The method of analyzing assembly risk is not limited to those disclosed in this document and can be adjusted according to the product characteristics and/or production needs. After completing the determination in step S350, the processor 30 generates the corresponding first result R1 or second result R2. If the distance D is greater than or equal to the predetermined combination tolerance, the processor 30 outputs the first result R1 (indicating higher assembly risk); if the distance D is less than the predetermined combination tolerance, processor 30 outputs the second result R2 (indicating lower assembly risk). Therefore, the assembly risk of the first result R1 is higher than that of the second result R2. Furthermore, the first result R1 and the second result R2 may contain data of the paired combinations 80 with maximum tolerances that exceed the predetermined combination tolerance. The operator of the CAD system 10 may modify the design drawing of the component according to the first result R1 and the second result R2, to reduce the risk of assembly mismatch. The first result R1 and the second result R2 can be stored and preserved in a digital file, and the present disclosure is not limited to this.

In step S360, the processor 30 outputs the first result R1 or the second result R2. In addition to storing and preserving the results in digital file format, the processor 30 may also display the results on a display or sound an alarm to present the first result R1 or the second result R2.

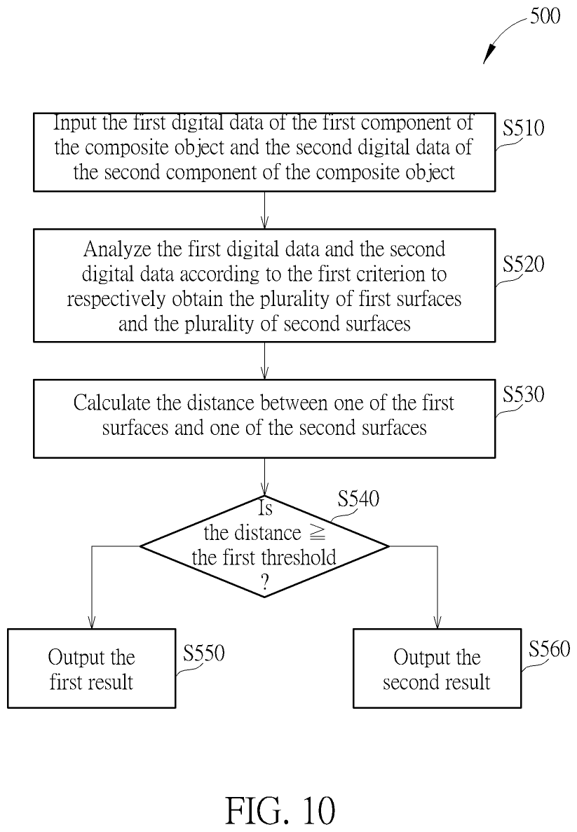

FIG. 10 is a flowchart of a digital data processing method 500 for a composite object in another embodiment of the CAD system 10. The digital data processing method 500 for a composite object comprises the following steps S510 to S560:
Step S510: Input the first digital data D1 of the first component 62 and the second digital data D2 of the second component 63 of the composite object 60;
Step S520: Analyze the first digital data D1 and the second digital data D2 according to the first criterion S1 to obtain a plurality of first surfaces 81 and a plurality of second surfaces 82, where the first criterion S1 can be predetermined by the user;
Step S530: Calculate the distance between one of the a plurality of first surfaces 81 and one of the a plurality of second surfaces 82;
Step S540: Determine whether the distance calculated in step S530 is greater than or equal to a first threshold; if the distance is greater than or equal to the first threshold, go to step S550; otherwise, go to step S560;
Step S550: Output the first result R1.
Step S560: Output the second result R2.

The first criterion S1 mentioned above may comprise that the normal vectors 54 of the first triangular pieces 52 constituting part of the first surfaces 81 are in the same direction, and the normal vectors 55 of the second triangular pieces 53 constituting part of the second surfaces 82 are in the same direction. In addition, in step S520, the processor 30 analyzes the first digital data D1 and the second digital data D2 to obtain the plurality of first surfaces 81 and the plurality of second surfaces 82 that meet the first criterion S1, which are composed of the first triangular pieces 52 and the second triangular pieces 53 respectively that meet the first criterion S1.

In another embodiment, the first criterion S1 may further comprise that the first triangular pieces 52 constituting one of the first surfaces 81 are orthogonal to a certain direction (such as the X-axis, Y-axis, or Z-axis). In another embodiment, the first criterion S1 may further comprise that the first triangular pieces 52 constituting one of the first surface 81 are inclined to one direction (such as the X-axis, Y-axis, or Z-axis). In another embodiment, before step S530, the processor 30 calculates the Intersection over Union (IoU) between one of the first surfaces 81 and one of the second surfaces 82, and only performs step S530 when the IoU is greater than or equal to the second threshold.

Through the digital data processing method for the combination object in the above embodiments of the present disclosure, the product developers would analyze and grasp the possible assembly risks between various components through geometric deconstruction, and then adjust the original design to avoid assembly risks before manufacturing product samples.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A computer-aided design system, comprising:
a storage device for storing software; and
a processor coupled to the storage device, for reading the software from the storage device and performing following operations by executing the software:
inputting first digital data of a first component of a composite object;
inputting second digital data of a second component of the composite object;
analyzing the first digital data and the second digital data according to a first criterion to respectively obtain a plurality of first surfaces and a plurality of second surfaces;
calculating a distance between one of the first surfaces and one of the second surfaces; and
outputting a first result when the distance is greater than or equal to a first threshold, and outputting a second result when the distance is less than the first threshold.

2. The computer-aided design system of claim 1, wherein the first component is represented by a plurality of first triangular pieces, the second component is represented by a plurality of second triangular pieces, the first digital data comprises coordinates of vertices of the first triangular pieces and normal vectors of the first triangular pieces, and the second digital data comprises coordinates of vertices of the second triangular pieces and normal vectors of the second triangular pieces.

3. The computer-aided design system of claim 2, wherein analyzing the first digital data and the second digital data according to the first criterion to respectively obtain the plurality of first surfaces and the plurality of second surfaces comprises:
analyzing first triangular pieces and second triangular pieces that meet the first criterion in the first digital data and the second digital data to respectively obtain the first surfaces composed of the first triangular pieces that meet the first criterion and the second surfaces composed of the second triangular pieces that meet the first criterion.

4. The computer-aided design system of claim 2, wherein the first criterion comprises normal vectors of first triangular pieces constituting one of the first surfaces and normal vectors of second triangular pieces constituting one of the second surfaces being in the same direction.

5. The computer-aided design system of claim 2, wherein the first criterion comprises a plurality of first triangular pieces constituting one of the first surfaces being orthogonal to one direction.

6. The computer-aided design system of claim 2, wherein the first criterion comprises a plurality of first triangular pieces constituting one of the first surfaces being inclined to one direction.

7. The computer-aided design system of claim 1, wherein before calculating the distance between one of the first surfaces and one of the second surfaces, the processor calculates an Intersection over Union (IoU) of the one of the first surfaces and the one of the second surfaces, and the IoU is greater than or equal to a second threshold.

8. The computer-aided design system of claim 1, wherein the first threshold is a predetermined combination tolerance.

9. The computer-aided design system of claim 1, wherein the first result and the second result respectively represent combination risks of the composite object, and the combination risk represented by the first result is higher than the combination risk represented by the second result.

10. A method for processing digital data of a composite object, comprising:
inputting first digital data of a first component of the composite object;
inputting the second digital data of the second component of the composite object;
analyzing the first digital data and second digital data according to a first criterion to respectively obtain a plurality of first surfaces and a plurality of second surfaces;
calculating a distance between one of the first surfaces and one of the second surfaces; and
outputting a first result when the distance is greater than or equal to a first threshold, and outputting a second result when the distance is less than the first threshold.

11. The method for processing the digital data of the composite object of claim 10, wherein the first component is represented by a plurality of first triangular pieces, the second component is represented by a plurality of second triangular pieces, the first digital data comprises coordinates of vertices of the first triangular pieces and normal vectors of the first triangular pieces, and the second digital data comprises coordinates of vertices of the second triangular pieces and normal vectors of the second triangular pieces.

12. The method for processing the digital data of the composite object of claim 11, wherein analyzing the first digital data and the second digital data according to the first criterion to respectively obtain the plurality of first surfaces and the plurality of second surfaces comprises:
analyzing first triangular pieces and second triangular pieces that meet the first criterion in the first digital data and the second digital data to respectively obtain the first surfaces composed of the first triangular pieces that meet the first criterion and the second surfaces composed of the second triangular pieces that meet the first criterion.

13. The method for processing the digital data of the composite object of claim 11, wherein the first criterion comprises normal vectors of first triangular pieces constituting one of the first surfaces and normal vectors of second triangular pieces constituting one of the second surfaces being in the same direction.

14. The method for processing the digital data of the composite object of claim 11, wherein the first criterion comprises a plurality of first triangular pieces constituting one of the first surfaces being orthogonal to one direction.

15. The method for processing the digital data of the composite object of claim 11, wherein the first criterion comprises a plurality of first triangular pieces constituting one of the first surfaces being inclined to one direction.

16. The method for processing the digital data of the composite object of claim 10, further comprising before calculating the distance between one of the first surfaces and one of the second surfaces, calculating an Intersection over Union (IoU) of the one of the first surfaces and the one of the second surfaces, the IoU being greater than or equal to a second threshold.

17. The method for processing the digital data of the composite object of claim 10, wherein the first threshold is a predetermined combination tolerance.

18. The method for processing the digital data of the composite object of claim 10, wherein the first result and the second result respectively represent combination risks of the composite object, and the combination risk represented by the first result is higher than the combination risk represented by the second result.
